(19) United States
(12) Patent Application Publication
(10) Pub. No.: US 2025/0132827 A1
(43) Pub. Date: Apr. 24, 2025

(54) METHOD AND APPARATUS FOR IMPROVING SIDELOBE CANCELLATION IN CODED OPTICAL TIME-DOMAIN REFLECTOMETRY

(71) Applicant: HUAWEI TECHNOLOGIES CO., LTD., Shenzhen (CN)

(72) Inventors: Xiang LIN, Kanata (CA); Zhiping JIANG, Kanata (CA)

(73) Assignee: HUAWEI TECHNOLOGIES CO., LTD., SHENZHEN (CN)

(21) Appl. No.: 18/382,299

(22) Filed: Oct. 20, 2023

(51) Int. Cl. H04B 10/071; H04B 10/516

(52) U.S. Cl. CPC H04B 10/071; H04B 10/5162

(57) ABSTRACT

Methods and apparatus for characterizing optical fiber links by optical time-domain reflectometry are disclosed. To resolve compromises between the signal-to-noise ratio, duration, and resolution of optical-time domain reflectometry measurements, embodiments of the present disclosure use coded sequences of return-to-zero light pulses. Each return-to-zero light pulse in a coded sequence includes a guard interval to mitigate the effects of pulse shape distortions. In some embodiments, the sequences of return-to-zero light pulses encode complementary Golay correlation codes. Some embodiments provide methods for encoding and decoding the sequences of return-to-zero pulse sequences. Some embodiments provide an optical time-domain reflectometry apparatus including a light source unit, optical coupler, light sensor, and processing device.

### CROSS-REFERENCE TO RELATED APPLICATIONS

This is the first application filed for the present invention.

### FIELD OF THE INVENTION

The present invention pertains to optical communications networks and in particular to a method and apparatus for improving optical time-domain reflectometry.

### BACKGROUND

Optical time-domain reflectometry (herein referred to as “reflectometry”) is a technique that is used to characterize and test the integrity of an optical fiber link, including when building, qualifying, maintaining, and troubleshooting fiber optic systems. The technique may be performed using an optoelectronic apparatus known as an optical time-domain reflectometer (OTDR) and may typically comprise generating a light pulse, injecting the pulse into an optical fiber link of interest, and detecting any returning light. Light that returns to the OTDR (the “back-response”) was scattered or reflected as it travelled through the optical fiber link, thereby providing an indicator for imperfections or optical losses in the optical fiber link. By recording the intensity of the light that returns over time, the distance to the imperfections and sources of loss can be determined. Because the intensity of the light that returns is usually weak, the process needs to be repeated for a large number of light pulses. However, repetitions of light pulses need to be separated by an interval that exceeds the round-trip propagation time for the optic fiber link to avoid overlap in the back-response.

To improve the signal-to-noise ratio in reflectometry measurements, coded sequences of light pulses may be used. For example, codes can be selected to have particular autocorrelation properties that enable a high number of pulses to be sent in the round-trip propagation time for the optical fiber in order to improve the signal-to-noise ratio. However, distortions to the pulses in practical systems, such as from linear or nonlinear effects, may impair the autocorrelation of a sequence of pulses by causing undesirable sidelobes in the autocorrelation signal. In some optical fiber links having large reflections, the sidelobes can dominate over the main signal of autocorrelations from the back-response, causing errors in the reflectometry measurements.

Therefore, there is a need for a method and apparatus for optical time-domain reflectometry that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for optical time-domain reflectometry.

A first aspect of the present disclosure is to provide a method for characterizing an optical fiber link (OFL), which may have an input end. The method may comprise: encoding a plurality of binary codes (BCs) in light to obtain an encoded light pulse sequence, each BC of the plurality of BCs being represented, in the encoded light pulse sequence, by a respective series of ON states and OFF states, and each ON state having a same duration and a respective guard interval; coupling the encoded light pulse sequence into the input end of the OFL; detecting, at the input end of the OFL, a back-response of the encoded light pulse sequence; and decoding the back-response of the encoded light pulse sequence in accordance with the plurality of BCs to obtain a decoded reflectometry measurement characteristic of the OFL. In some embodiments, the method may further comprise determining each BC of the plurality of BCs. In some embodiments, the method may be repeated for one or more repetitions and may further comprise determining an average reflectometry measurement depending from the decoded reflectometry measurement of each repetition.

In some embodiments of the first aspect, the plurality of BCs may comprise a plurality of complementary pairs of unipolar correlation codes. Each complementary pair of unipolar correlation codes may correspond to a respective bipolar correlation code of a complementary pair of bipolar correlation codes, and each BC may be one unipolar correlation code of one complementary pair of unipolar correlation codes of the plurality of complementary pairs of unipolar correlation codes. In some embodiments, a sum of an autocorrelation of each bipolar correlation code of a complementary pair of bipolar correlation codes may be a delta function. In some embodiments, each bipolar correlation code may be a Golay code. In some embodiments, the back-response of the encoded light pulse sequence may comprise a plurality of back-response signals each corresponding to one unipolar correlation code of the plurality of complementary pairs of unipolar correlation codes. In these embodiments, decoding the back-response of the encoded light pulse sequence in accordance with the plurality of BCs to obtain the decoded reflectometry measurement characteristic of the OFL may include: determining for each complementary pair of unipolar correlation codes, a respective differential back-response signal defined by a difference comprising the back-response signals corresponding to each unipolar correlation code of the respective complementary pair of unipolar correlation codes; determining, for each complementary pair of unipolar correlation codes, a respective bipolar correlation signal defined by a correlation comprising the respective bipolar correlation code and the respective differential back-response signal; and determining for the complementary pair of bipolar correlation codes, a sum comprised between the respective bipolar correlation signals of each complementary pair of unipolar correlation codes.

In some embodiments of the first aspect, each BC of the plurality of BCs may be a linear combination code. In some embodiments, each linear combination code may be a simplex code.

In some embodiments of the first aspect, the decoded reflectometry measurement may be an optical time-domain reflectometry trace indicating a respective back-response power from each of a plurality of distances along the OFL.

In some embodiments of the first aspect, the respective guard interval may be shorter than the same duration of each ON state. In other embodiments, the respective guard interval may be equitemporal to the same duration of each ON state.

In some embodiments of the first aspect, the OFL may include a plurality of optical fibers.

In some embodiments of the first aspect, each series of ON states and OFF states may have a same length being a power of two, the power being an integer.

A second aspect of the present disclosure is to provide an optical time-domain reflectometer (OTDR). The OTDR may comprise: a light source unit configured to generate a light pulse sequence encoding a plurality of binary codes (BCs), each BC of the plurality of BCs being represented, in the light pulse sequence, by a respective series of ON states and OFF states, and each ON state having a same duration and a respective guard interval; an optical coupler configured to couple the light pulse sequence into an optical fiber link (OFL) at an input end of the OFL and receive a back-response of the light pulse sequence from the input end of the OFL; a light sensor configured to, for the light pulse sequence, detect the back-response of the light pulse sequence; and a processing device configured to decode the back-response in accordance with the plurality of BCs to obtain a decoded reflectometry measurement characteristic of the OFL.

In some embodiments of the second aspect, the light source unit may include a laser. In some embodiments, the light source unit may include a laser coupled to an optical modulator. In some embodiments, the light sensor may be a photodetector. In some embodiments, the optical coupler may be an optical circulator. In some embodiments, the processing device may include a digital storage oscilloscope.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows a schematic of an OTDR typical of the prior art.

FIG. 1B shows a graph of optical power versus time for a light pulse train typical of the prior art.

FIG. 2A shows a first complementary Golay code of a pair of complementary Golay codes, in accordance with embodiments of the present disclosure.

FIG. 2B shows a second complementary Golay code of a pair of complementary Golay codes, in accordance with embodiments of the present disclosure.

FIG. 2C shows normalized autocorrelations for a pair of complementary Golay codes, in accordance with embodiments of the present disclosure.

FIG. 2D shows a normalized sum of autocorrelations of a pair of complementary Golay codes, in accordance with embodiments of the present disclosure.

FIG. 3A shows an example typical of the prior art of unipolar pulse sequences encoding a first Golay code.

FIG. 3B shows an example typical of the prior art of unipolar pulse sequences encoding a second Golay code.

FIG. 3C shows an example of a normalized sum of autocorrelations from unipolar pulse sequences typical of the prior art.

FIG. 4 shows a flowchart of a method for optical time-domain reflectometry in accordance with embodiments of the present disclosure.

FIG. 5A shows an example of encoding a non-return-to-zero light pulse sequence according to formats typical of the prior art.

FIB. 5B shows an example of encoding a return-to-zero light pulse sequence according to embodiments of the present disclosure.

FIG. 6A shows an example of unipolar return-to-zero pulse sequences encoding Golay codes, in accordance with embodiments of the present disclosure.

FIG. 6B shows an example of unipolar return-to-zero pulse sequences encoding Golay codes, in accordance with embodiments of the present disclosure.

FIG. 6C shows an example an example of a normalized sum of autocorrelations from unipolar RZ pulse sequences, in accordance with embodiments of the present disclosure.

FIG. 7A shows an example of an optical fiber link for which embodiments of the present disclosure may be implemented.

FIG. 7B shows an example of a reflectometry trace obtained using methods typical of the prior art.

FIG. 7C shows an example of a reflectometry trace obtained in accordance with embodiments of the present disclosure.

FIG. 8A shows an OTDR in accordance with embodiments of the present disclosure.

FIG. 8B shows another OTDR in accordance with embodiments of the present disclosure.

FIG. 9 shows an apparatus for implementing methods of the present disclosure.

FIG. 10 shows a schematic of an embodiment of an electronic device that may implement at least part of the systems of the present disclosure.

It will be noted that throughout the appended drawings, like features are identified by like reference numerals.

### DETAILED DESCRIPTION

Embodiments of the present disclosure are generally directed towards providing methods and apparatus for improving optical time-domain reflectometry (herein referred to as “reflectometry”) for characterizing optical fiber links. Embodiments may use coded sequences of light with return-to-zero pulses to improve the signal-to-noise ratio of reflectometry measurements. Each return-to-zero pulse in a sequence may have a guard interval that separates it from neighbouring pulses. In some embodiments, the coded sequences of light may encode Golay codes. Embodiments may provide methods for encoding and decoding the coded sequences of light. Some embodiments may provide an OTDR, which may comprise a light source unit, an optical coupler, a light sensor, and a processing device.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be used interchangeably throughout the disclosure: output signal, back-response, back-reflection and back-scatter, and returning light; optical time-domain reflectometry, and reflectometry; reflectometry measurement, decoded reflectometry measurement, and reflectometry trace; and optical fiber link and optical communication link.

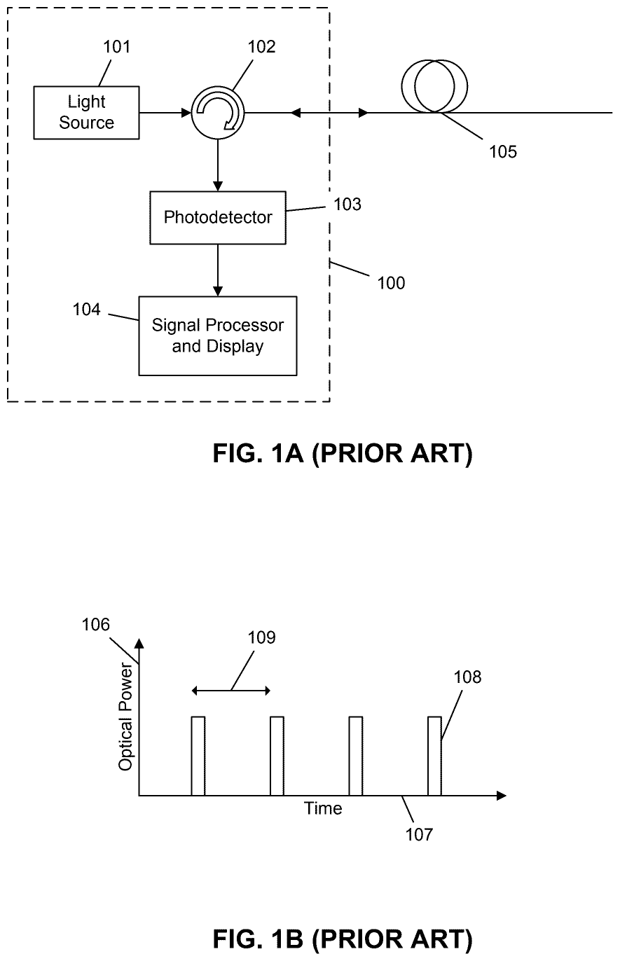

FIG. 1A shows a schematic of an OTDR 100 typical of the prior art. The OTDR 100 comprises a light source 101, an optical circulator 102, a photodetector 103, and a signal processor and display 104. The light source 101, which may, for example, be a laser, is configured to generate pulses of light, which can then be injected into an optical fiber link 105 to characterize it by reflectometry. The optical fiber link 105 could comprise a plurality of optical fibers coupled together as well as other optical elements such as fiber splices, connectors, and amplifiers. As each pulse of light travels through the optical fiber link 105, it may encounter imperfections and sources of loss that cause scattering or back reflections, at least partially. Scattering, such as Rayleigh backscattering, or back reflections, such as from a fiber interface, can cause, at least partially, a light pulse to travel back through the optical fiber link 105 towards the OTDR 100. When arriving at the OTDR 100, the back-scattered and/or back-reflected light (i.e., a “back-response”) is received by the optical circulator 102, which then directs it to the photodetector 103. The photodetector 103 measures the optical power, or intensity, of the light received from the optical fiber link 105 as a function of time elapsed since the pulse was sent. The signal processor and display 104, knowing the group velocity of light in the optical fiber link, is configured to convert this measurement of power over time to a measurement of relative power over distance, also known as a reflectometry trace. Thus, the reflectometry trace can indicate the locations of sources of loss in the optical fiber link 105 and the transmission integrity of the optical fiber link 105.

FIG. 1B shows a graph of optical power 106 versus time 107 for a series of light pulses 108 defining a light pulse train. With reflectometry of the prior art, a light pulse train is needed to measure a signal that is appreciable in comparison to the measurement noise because the light that returns to an OTDR 100 from an optical fiber link 105 is usually weak. Typically, averaging a reflectometry measurement over a large number of light pulses 108 is needed to achieve a reasonable signal-to-noise ratio (SNR). Each sequential pair of light pulses 108 in the light pulse train must be separated by a pulse spacing 109 that is greater than the round-trip transit time RT for the optical fiber link 105 in order to avoid overlap in the signals from the sequential light pulses 108. This need for a large number of light pulses 108 separated by wide pulse spacings 109 can prolong reflectometry measurements. Although the width of each light pulse 108 can be narrowed to improve the resolution of a measurement and minimize overlap, narrowing the pulses degrades the measurement SNR. Therefore, compromises must be made between the SNR, duration, and resolution of the measurement.

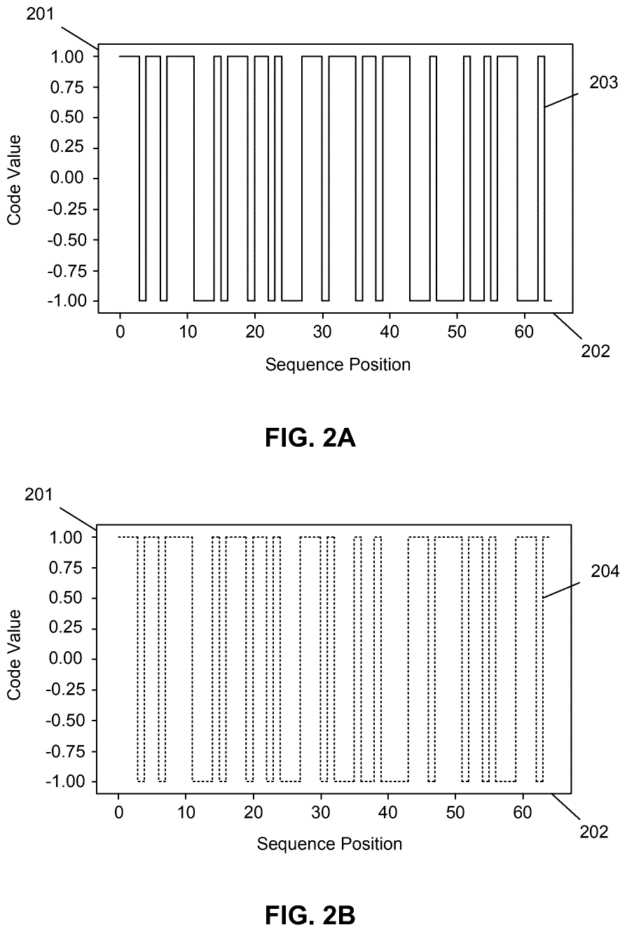

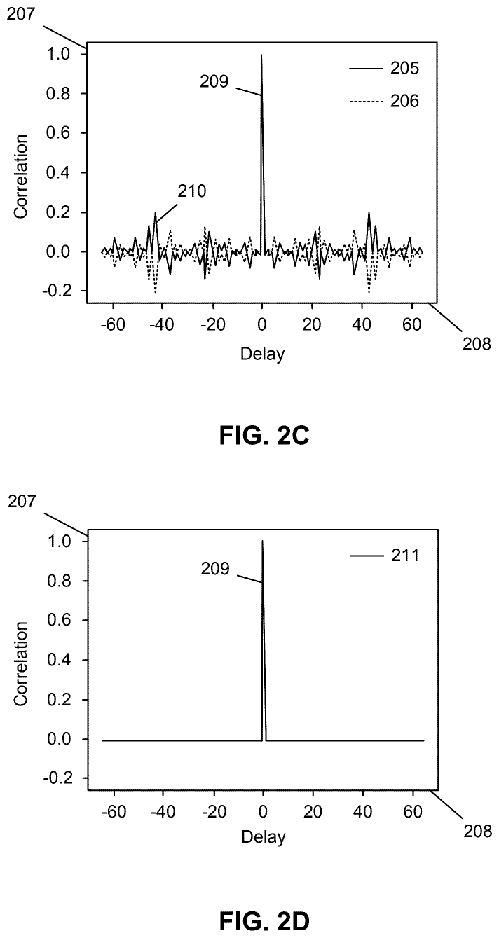

Approaches for overcoming the compromises between measurement SNR, duration, and resolution in the prior art for reflectometry have included using coded sequences of light pulses 108. With coded sequences of light pulses 108, more light pulses 108 can be sent within RT because they can be coded to decouple the effects of interference on a reflectometry trace. FIGS. 2A and 2B show code values 201 by sequence position 202 for two example sequences, respectively sequence A 203 and sequence B 204. In this example, sequence A 203 and sequence B 204 are a pair of complementary Golay codes with 64 values. Complementary Golay codes are bipolar (valued either 1 or −1) correlation codes and have autocorrelations that sum together to form a delta function. The number of values in a Golay code N is given by 2 to the power of an order, where the order is an integer value. For example, the number of values in a Golay code may be 32 or 64. The autocorrelation relation for sequence A 203 and sequence B 204 having N values can be expressed as:

$$A ⊗ A + B ⊗ B = 2 N δ \qquad ( 1 )$$

where ⊗ indicates correlation and δ indicates a delta function. FIG. 2C shows normalized autocorrelations for sequence A 203 and sequence B 204, respectively autocorrelation A_{crl} 205 (A⊗A) and autocorrelation B_{crl} 206 (B⊗B), on a graph of correlation 207 versus delay 208. Each autocorrelation shows a central peak 209 where the respective sequence aligns with itself perfectly and shows sidelobes 210 arising from correlations at other alignments. The complementary nature of the Golay codes causes the sidelobes 210 of autocorrelation A_{crl} 205 and autocorrelation B_{crl} 206 to sum to zero. FIG. 2D shows a normalized graph of the sum 211 of autocorrelation A 205 and autocorrelation B 206, wherein the central peak 209 forms a delta function and the sidelobes 210 cancel entirely.

When using Golay codes for reflectometry, the observed signals of light received from an optical fiber link 105 (i.e., “back-response signals”) need to be decoded to remove the effects of interference between the light pulses 108. The light received for sequence A 203 and sequence B 204, output signals r_{A} and r_{B}, can be expressed as a convolution of the respective codes and the back-reflection and back-scattering response h of the optical fiber link:

$${r}_{A} = A * h \qquad ( 2 )$$

$${r}_{B} = B * h \qquad ( 3 )$$

where * indicates convolution. The response h can be obtained from the output signals through the following relations combining Equations 1 to 3:

$$2 Nh = ( A ⊗ A + B ⊗ B ) * h = ( A ⊗ A ) * h + ( B ⊗ B ) * h = A ⊗ ( A * h ) + B ⊗ ( B * h ) = A ⊗ {r}_{A} + B ⊗ {r}_{B} \qquad ( 4 )$$

However, because the bipolar Golay codes cannot be represented physically in light (i.e., the intensity of light cannot be negatively valued), sequence A 203 and sequence B 204 must be further separated into respective complementary pairs of unipolar correlation codes (valued either 0 or 1), respectively A⁺ and A⁻, and B⁺ and B⁻:

$${A}^{+} = ( 1 + A ) / 2 \qquad ( 5 )$$

$${A}^{-} = ( 1 - A ) / 2 \qquad ( 6 )$$

$${B}^{+} = ( 1 + B ) / 2 \qquad ( 7 )$$

$${B}^{-} = ( 1 - B ) / 2 \qquad ( 8 )$$

With these four unipolar codes, four output signals would be obtained, r_{A}+, r_{A}−, r_{B}+, and r_{B}−. From these output signals, the corresponding signals r_{A} and r_{B} can be obtained:

$${r}_{A} = {r}_{A +} - {r}_{A -} \qquad ( 9 )$$

$${r}_{B} = {r}_{B +} - {r}_{B -} \qquad ( 10 )$$

It follows then that Equation (4) can be written as:

$$2 Nh = A ⊗ ( {r}_{A +} - {r}_{A -} ) + B ⊗ ( {r}_{B +} - {r}_{B -} ) \qquad ( 11 )$$

Thus, in using two pairs of complementary unipolar correlation codes, a decoded reflectometry trace can be obtained by finding the difference (i.e., a “differential back-response signal”) between the output signals of each complementary pair of unipolar correlation codes, correlating the differences with the corresponding bipolar correlation codes to obtain bipolar correlation signals, and summing the bipolar correlation signals.

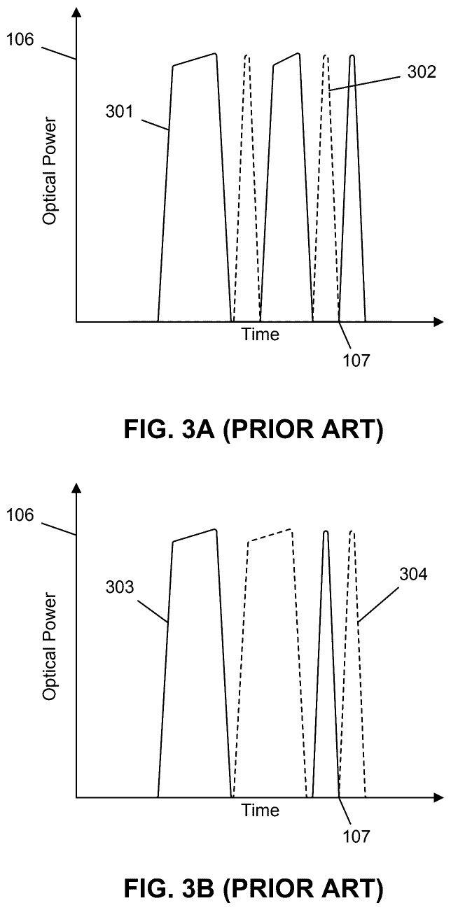

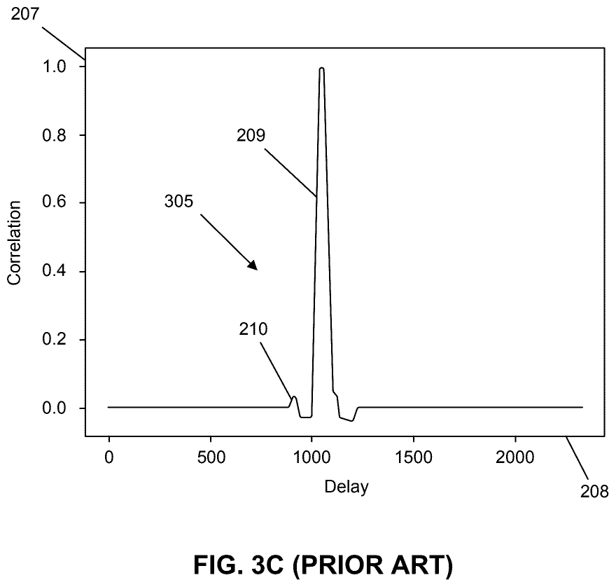

FIGS. 3A and 3B show examples of unipolar pulse sequences encoding Golay codes as they typically appear in reflectometry. FIG. 3A shows a unipolar sequence A⁺ 301 and a unipolar sequence A⁻ 302, while FIG. 3B shows a unipolar sequence B⁺ 303 and a unipolar sequence B⁻ 304. These unipolar sequences correspond to bipolar sequences A=[1, 1, 1, −1, 1, 1, −1, 1] and B=[1, 1, 1, −1, −1, −1, 1, −1]. In these examples, consecutive light pulses 108 encoding values of 1 in the unipolar sequences are joined as a continuous pulse with a duration representative of the number of consecutive light pulses 108, in accordance with a non-return-to-zero (NRZ) encoding format. Light pulses 108 of typical OTDRs 100 can be distorted, as shown in FIGS. 3A and 3B, by linear or nonlinear effects in the OTDR 100, such as in a photodiode used to detect the light returning to the OTDR 100, or in the optical fiber link 105. These distortions can break the symmetry, and thus the complementary nature, of the pulse sequences. FIG. 3C shows a normalized sum of the autocorrelations 305 according to Equation (1) for the example sequences of FIGS. 3A and 3B. Unlike the ideal case of FIG. 2D, the normalized sum of FIG. 3C does not only show a delta function given by a central peak 209 but also sidelobes 210 that remain due to the asymmetry of the light pulses 108. In optical fiber links 105 with relatively large reflections, the sidelobes 210 of a sum of autocorrelations 305 of the reflected light can exceed in strength the central peak 209 of the sum of autocorrelations 305 of the backscattered light. Ultimately, even small deviations from the ideal delta function appearing as sidelobes 210 can impair the reflectometry trace.

Embodiments of the present disclosure may provide sequences of light pulses 208 using return-to-zero pulses that enable coded reflectometry to overcome compromises between measurement SNR, duration, and resolution.

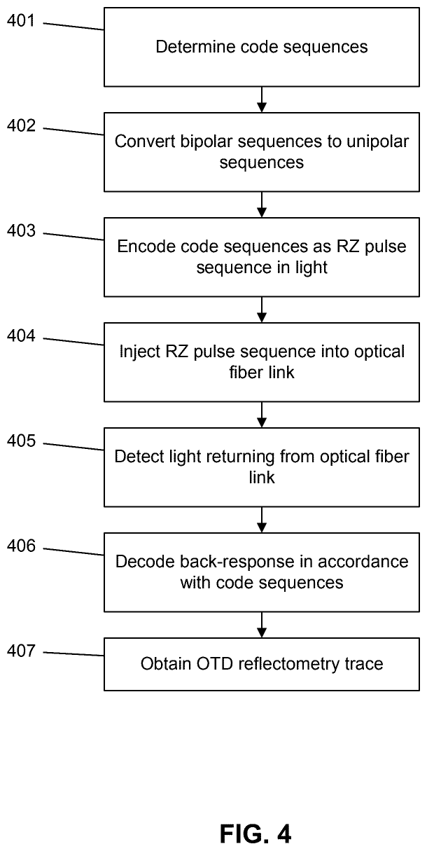

FIG. 4 shows a flowchart of a method for reflectometry towards characterizing an optical fiber link 105 (or an “optical communication link”) in accordance with an embodiment of the present disclosure. At action 401, a plurality of code sequences may be selected. The code sequences may be binary codes (BCs), which may, for example, include correlation codes such as Golay codes, and linear combination codes such as simplex codes. For Golay codes, action 401 may include generating a complementary pair of bipolar correlation codes, such as sequence A 203 and sequence B 204. The sum of an autocorrelation of each bipolar correlation code of the complementary pair may be a delta function, in accordance with Equation (1). The length of each code sequence may be a power of two, with the power being an integer. At action 402, bipolar code sequences may be converted to unipolar code sequences to produce complementary pairs of unipolar codes. For Golay codes, action 402 may produce two complementary pairs of unipolar correlation codes, such as A⁺ and A⁻, and B⁺ and B⁻ as defined by Equations (5) to (8).

At action 403, the plurality of code sequences may be encoded in light as a sequence of light pulses 108 (or a “light pulse sequence”). Each code sequence may be represented as a respective series of ON states and OFF states. ON states may be where the light has a non-zero intensity and OFF states may be where the light has zero intensity, or near-zero intensity. The intensity of the ON state may be selected in accordance with the reflectometry measurement. The plurality of codes may be encoded in one sequence of light pulses 108, or each code may be encoded as a separate sequence of light pulses 108. The plurality of code sequences may be encoded in a return-to-zero (RZ) format, wherein each ON state has a same duration T and a respective guard interval. With return-to-zero pulses, consecutive pulses encoding values of 1 in a unipolar sequence may be distinct and not joined; the light intensity of an ON state may return to zero intensity before a succeeding ON state begins. The time for which the light intensity returns to zero intensity may be termed a guard interval. The guard interval may have, for example, a duration that is the same as the duration T (i.e., “equitemporal”) or a duration that is a fraction of T such as 0.5 T or 0.25 T.

At action 404, the sequence of light pulses 108 may be injected into an input end of the optical fiber link 105. The optical fiber link 105 may comprise a plurality of optical fibers as well as other optical elements such as fiber splices, connectors, and amplifiers that are coupled in series. The light pulses 108 may scatter and/or reflect off sources of loss in the optical fiber link 105 and may be sent back, at least partially, through the optical fiber link 105 (i.e., as a “back-response”). Therefore, the back-response may include both back-scattered and back-reflected light. At action 405, the back-response returning to the input end of the optical fiber link 105 may be detected as a measure of optical power over time. For Golay codes, action 405 may include detecting the back-response as four output signals (or “back-response signals”), r_{A}+, r_{A}−, r_{B}+, and r_{B}−.

At action 406, the back-response may be decoded in accordance with the plurality of code sequences. For Golay codes, action 406 may include decoding the four output signals r_{A}+, r_{A}−, r_{B}+, and r_{B}− according to Equation (11). Upon decoding the back-response, a reflectometry trace (i.e., a “decoded reflectometry measurement”) may be obtained, at action 407. The reflectometry trace may indicate the optical power reflected, or relative power, at each distance for a plurality of distances along the optical fiber link 105.

In some embodiments, the method shown in FIG. 4 may be repeated for one or more repetitions. Each repetition may produce a respective reflectometry trace at action 406. The method may then further include determining an average reflectometry trace (i.e., an “average reflectometry measurement”) that is an average of the reflectometry traces produced in each repetition.

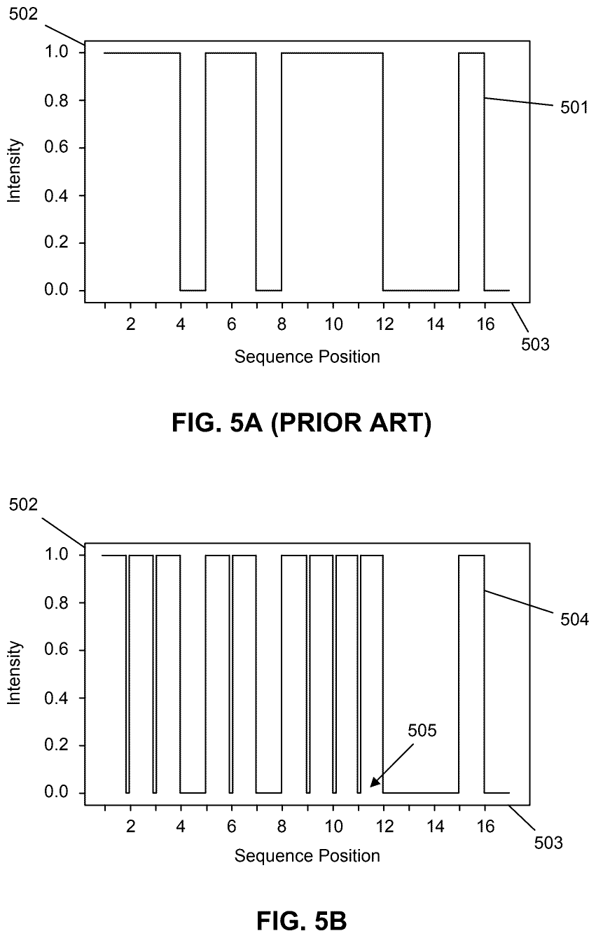

FIG. 5A shows an example of encoding a NRZ light pulse sequence 501 according to formats typical of the prior art. The NRZ light pulse sequence 501 is shown as a normalized intensity 502 as a function of sequence position 503. For each consecutive series of pulses in the ON state, for example the series of pulses including pulses 8 and 11, the NRZ light pulse sequence 501 remains in the ON state, having a normalized intensity of 1. FIG. 5B shows an example of encoding a RZ light pulse sequence 504 according to embodiments of the present disclosure. For each ON state, for example pulses 8 to 10, the RZ light pulse sequence 504 returns to zero intensity after the respective ON state, as shown by a plurality of guard intervals 505.

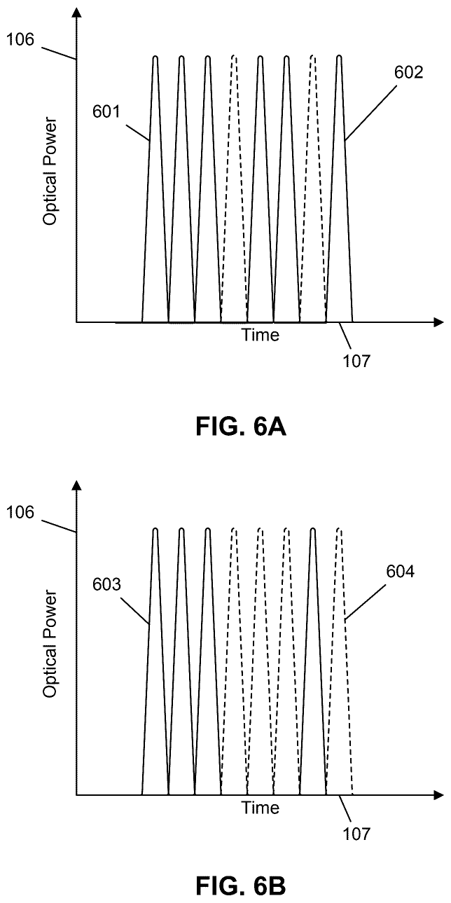

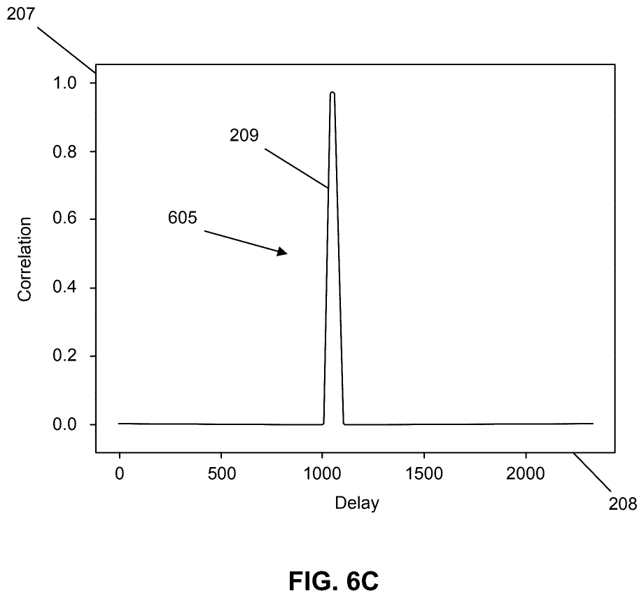

FIGS. 6A and 6B show examples of RZ light pulse sequences respectively encoding A⁺ and A⁻, and B⁺ and B⁻ complementary unipolar Golay codes (A⁺ shown as sequence 601, A⁻ as sequence 602, B⁺ as sequence 603, B⁻ and as sequence 604), in accordance with embodiments of the present disclosure. These unipolar code sequences correspond to bipolar sequences A=[1, 1, 1, −1, 1, 1, −1, 1] and B=[1, 1, 1, −1, −1, −1, 1, −1], as also shown in FIGS. 3A and 3B but in NRZ format. In contrast with FIGS. 3A and 3B, the RZ light pulse sequences of FIGS. 6A and 6B show light pulses 108 that are more identical and lack distortions. FIG. 6C shows a normalized sum of the autocorrelations 605 according to Equation (1) for the example sequences of FIGS. 6A and 6B. Unlike the normalized sum of autocorrelations 305 of FIG. 3C, the normalized sum of autocorrelations 605 of FIG. 6C shows a delta function with only a central peak 209 and no appreciable sidelobes 210.

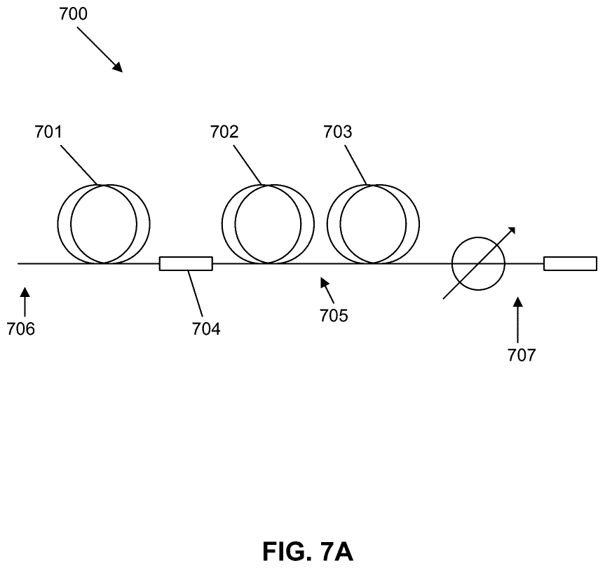

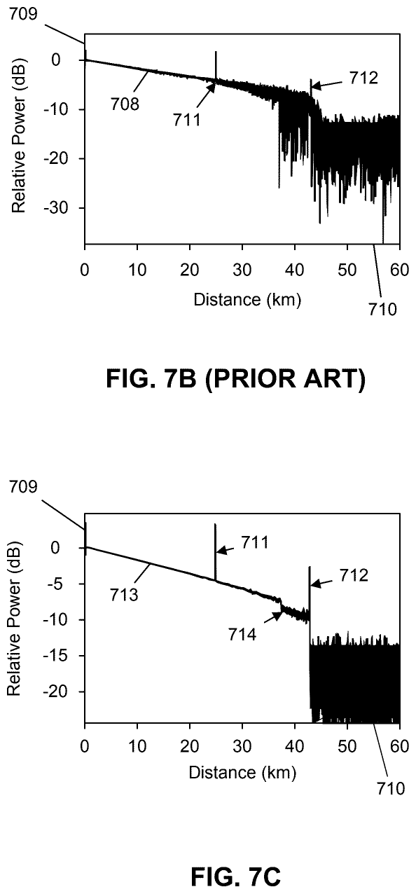

FIG. 7A shows an example optical fiber link 700 for which embodiments of the present disclosure may be implemented. The optical fiber link 700 comprises a first fiber section 701 with a length of about 25 kilometers, a second fiber section 702 with a length of about 13 kilometers, and a third fiber section 703 with a length of about 6 kilometers. The first fiber section 701 is connected to the second fiber section 702 through a connector 704, and the second fiber section 702 and the third fiber section 703 are separated by a splice 705 with an associated bend that causes losses. The optical fiber link further has an input end 706 and a fiber termination 707 at the opposing end. FIG. 7B shows an example of a reflectometry trace 708 obtained using complementary Golay codes encoded by a NRZ light pulse sequence for the optical fiber link 700 of FIG. 7A. The reflectometry trace 708 is plotted as relative power 709 (in decibels) as a function of distance 710 (in kilometers) along the optical fiber link 700. The reflectometry trace 708 shows a first reflection 711 at the connector 704 and a second reflection 712 at the fiber termination 707. In contrast with FIG. 7B, FIG. 7C shows an example of a reflectometry trace 713 obtained using complementary Golay codes encoded by a RZ light pulse sequence for the optical fiber link 700 of FIG. 7A. The reflectometry trace 713 again shows the first reflection 711 and the second reflection 712 but also shows a bending loss 714 at the splice 705 with the associated bend. The bending loss 714 is unresolvable in the reflectometry trace 708 of FIG. 7B but resolvable in the reflectometry trace 713 of FIG. 7C because of an improved SNR associated with using an RZ light pulse sequence.

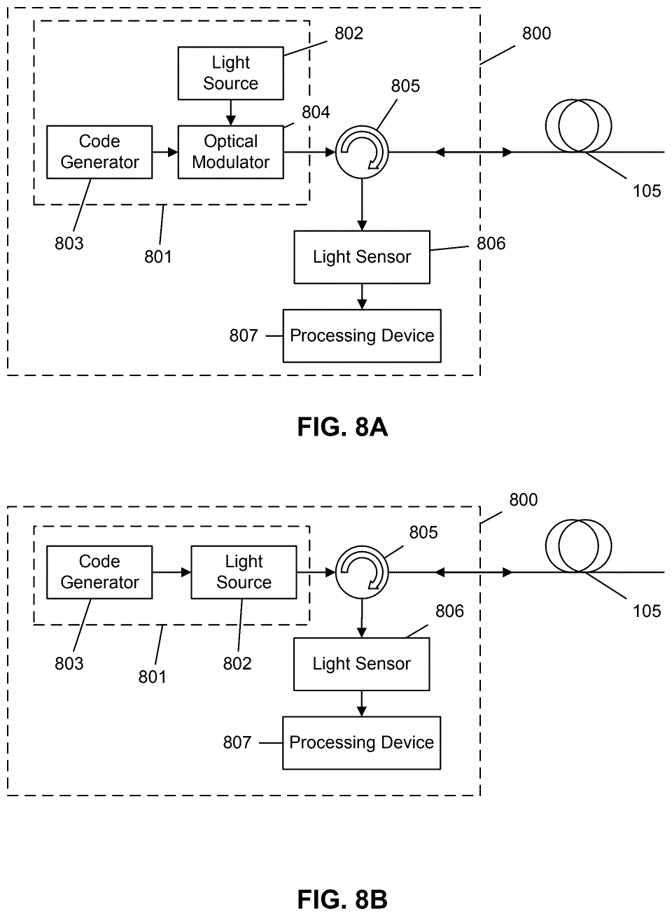

FIG. 8A shows an OTDR 800 in accordance with an embodiment of the present disclosure. The OTDR 800 may be configured to implement methods of the present disclosure, as described, for example, in relation to FIG. 4. The OTDR 800 may comprise a light source unit 801, an optical coupler 805, a light sensor 806, and a processing device 807. The light source unit 801 may be configured to select a plurality of codes such as complementary Golay codes, generate light, and encode the plurality of codes as an RZ light pulse sequence in the light. The light source unit 801 may include a light source 802, which may, for example, be a laser. The light source unit 801 may optionally include a code generator 803 and an optical modulator 804. The code generator 803 may be configured to encode the plurality of codes, by the optical modulator 804, in light from the light source 802. The light source unit 801 may further be configured to control the wavelength, duration, shape, and/or duty cycle of light pulses in the RZ light pulse sequences. The light source unit 801 may also include other components, such as an optical amplifier, a wavelength selective switch, and an arrayed waveguide grating. The optical coupler 805 may be configured to receive the RZ light pulse sequences from the light source unit 801 and couple them into an input end of an optical fiber link 105 for characterization. The optical coupler 805 may further be configured to receive a back-response from the input end of the optical fiber link and direct the back-response to the light sensor 806. In some embodiments, the optical coupler 805 may, alternatively, be an optical circulator. The light sensor 806 may be configured to receive and detect the back-response from the optical coupler 805. The light sensor 806 may further be configured to generate a time-depending electrical signal that is proportional to the optical power of the back-response. The light sensor 806 may be a photodetector such as a photodiode, avalanche photodiode, or a phototransistor. The processing device 807 may be configured to decode the back-response detected by the light sensor 806 and to produce a reflectometry trace in accordance with the plurality of codes. The processing device 807 may further be configured to display the reflectometry trace. The processing device 807 may include a digital storage oscilloscope. FIG. 8B shows an OTDR 800 in accordance with another embodiment of the present disclosure wherein the code generator 803 may encode the plurality of codes in light from the light source 802 by the light source 802 itself.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

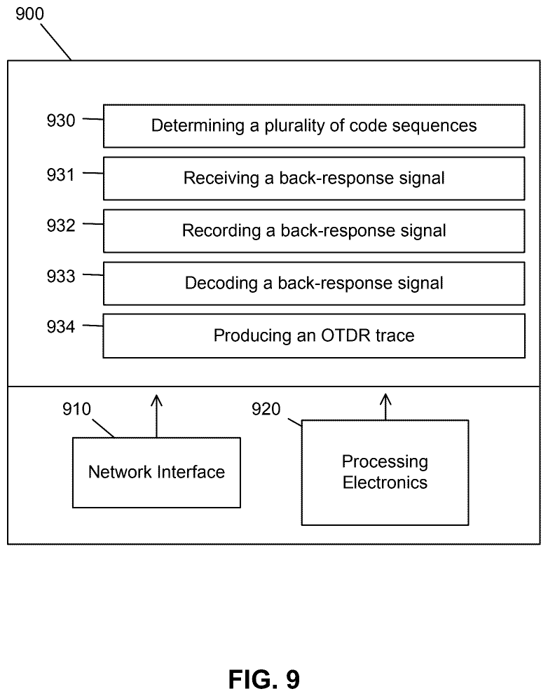

FIG. 9 shows an apparatus 900 for implementing, at least partly, the methods for reflectometry according to embodiments of the present invention. The apparatus 900 may, for example, be a part of the processing device 807 or the code generator 803 of the OTDR 800. The apparatus 900 may include a network interface 910 and processing electronics 920. The processing electronics 920 may include a computer processer executing program instructions stored in memory, or other electronics components such as digital circuitry, including for example FPGAs and ASICs. The network interface 910 may include an optical communication interface or radio communication interface, such as a transmitter and receiver. The apparatus may include several functional components, each of which may be partially or fully implemented using the underlying network interface 910 and processing electronics 920. Examples of functional components may include modules for determining 930 a plurality of code sequences, receiving 931 a back-response signal, recording 932 a back-response signal, decoding 933 a back-response signal, and producing 934 a reflectometry trace.

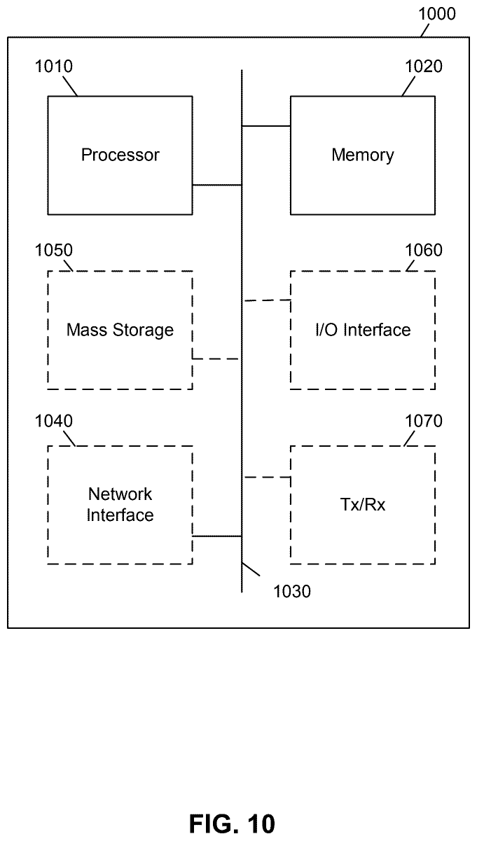

FIG. 10 shows a schematic diagram of an electronic device 1000 that may perform any or all of the operations of the above methods and features explicitly or implicitly described herein, according to different embodiments of the present disclosure. For example, the processing device 807 of OTDR 800 may be configured as electronic device 1000. As shown, the electronic device 1000 may include a processor 1010, such as a Central Processing Unit (CPU) or specialized processors such as a Graphics Processing Unit (GPU) or other such processor unit, memory 1020, and a bi-directional bus 1030 to communicatively couple the components of electronic device 1000. Electronic device 1000 may also optionally include a network interface 1040, non-transitory mass storage 1050, an I/O interface 1060, and a transceiver 1070. According to certain embodiments, any or all of the depicted elements may be utilized, or only a subset of the elements. Further, the electronic device 1000 may contain multiple instances of certain elements, such as multiple processors, memories, or transceivers. Also, elements of the hardware device may be directly coupled to other elements without the bi-directional bus 1030. Additionally or alternatively to a processor and memory, other electronics, such as integrated circuits, may be employed for performing the required logical operations.

The memory 1020 may include any type of tangible, non-transitory memory such as static random access memory (SRAM), dynamic random access memory (DRAM), synchronous DRAM (SDRAM), read-only memory (ROM), any combination of such, or the like. The mass storage element 1050 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1050 may have recorded thereon statements and instructions executable by the processor 1010 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic or optical element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for characterizing an optical fiber link (OFL), the OFL having an input end, the method comprising:
encoding a plurality of binary codes (BCs) in light to obtain an encoded light pulse sequence, each BC of the plurality of BCs being represented, in the encoded light pulse sequence, by a respective series of ON states and OFF states, each ON state having a same duration and a respective guard interval;
coupling the encoded light pulse sequence into the input end of the OFL;
detecting, at the input end of the OFL, a back-response of the encoded light pulse sequence; and
decoding the back-response of the encoded light pulse sequence in accordance with the plurality of BCs to obtain a decoded reflectometry measurement characteristic of the OFL.

2. The method of claim 1 wherein:
the plurality of BCs comprises a plurality of complementary pairs of unipolar correlation codes,
each complementary pair of unipolar correlation codes corresponds to a respective bipolar correlation code of a complementary pair of bipolar correlation codes, and
each BC is one unipolar correlation code of one complementary pair of unipolar correlation codes of the plurality of complementary pairs of unipolar correlation codes.

3. The method of claim 2 wherein a sum of an autocorrelation of each bipolar correlation code of a complementary pair of bipolar correlation codes is a delta function.

4. The method of claim 3 wherein each bipolar correlation code is a Golay code.

5. The method of claim 1 wherein each BC of the plurality of BCs is a linear combination code.

6. The method of claim 5 wherein each linear combination code is a simplex code.

7. The method of claim 1 further comprising:
determining each BC of the plurality of BCs.

8. The method of claim 2 wherein:
the back-response of the encoded light pulse sequence comprises a plurality of back-response signals each corresponding to one unipolar correlation code of the plurality of complementary pairs of unipolar correlation codes;
and
decoding the back-response of the encoded light pulse sequence in accordance with the plurality of BCs to obtain the decoded reflectometry measurement characteristic of the OFL includes:
determining, for each complementary pair of unipolar correlation codes, a respective differential back-response signal defined by a difference comprising the back-response signals corresponding to each unipolar correlation code of the respective complementary pair of unipolar correlation codes;
determining, for each complementary pair of unipolar correlation codes, a respective bipolar correlation signal defined by a correlation comprising the respective bipolar correlation code and the respective differential back-response signal;
and
determining, for the complementary pair of bipolar correlation codes, a sum comprised between the respective bipolar correlation signals of each complementary pair of unipolar correlation codes.

9. The method of claim 1 wherein the decoded reflectometry measurement is an optical time-domain reflectometry trace indicating a respective back-response power from each of a plurality of distances along the OFL.

10. The method of claim 1 wherein the respective guard interval is shorter than the same duration of each ON state.

11. The method of claim 1 wherein the respective guard interval is equitemporal to the same duration of each ON state.

12. The method of claim 1 wherein the OFL includes a plurality of optical fibers.

13. The method of claim 1 wherein each series of ON states and OFF states has a same length being a power of two, the power being an integer.

14. The method of claim 1 wherein the method is repeated for one or more repetitions and the method further comprises:
determining an average reflectometry measurement depending from the decoded reflectometry measurement of each repetition.

15. An optical time-domain reflectometer (OTDR) comprising:
a light source unit configured to generate a light pulse sequence encoding a plurality of binary codes (BCs), each BC of the plurality of BCs being represented, in the light pulse sequence, by a respective series of ON states and OFF states, each ON state having a same duration and a respective guard interval;
an optical coupler configured to couple the light pulse sequence into an optical fiber link (OFL) at an input end of the OFL and receive a back-response of the light pulse sequence from the input end of the OFL;
a light sensor configured to, for the light pulse sequence, detect the back-response of the light pulse sequence;
and
a processing device configured to decode the back-response in accordance with the plurality of BCs to obtain a decoded reflectometry measurement characteristic of the OFL.

16. The OTDR of claim 15 wherein the light source unit includes a laser.

17. The OTDR of claim 15 wherein the light source unit includes a laser coupled to an optical modulator.

18. The OTDR of claim 15 wherein the light sensor is a photodetector.

19. The OTDR of claim 15 wherein the optical coupler is an optical circulator.

20. The OTDR of claim 15 wherein the processing device includes a digital storage oscilloscope.
